(19) United States
(12) Patent Application Publication
(10) Pub. No.: US 2026/0365114 A1
(43) Pub. Date: Nov. 19, 2026

(54) SYSTEMS AND DEVICES FOR MODULAR PASS-THROUGH HITCH EXTENSIONS

(71) Applicant: Outdoor Buddy, LLC, Waukee, IA (US)

(72) Inventor: Jake Johnson, Waukee, IA (US)

(21) Appl. No.: 19/670,903

(22) Filed: May 7, 2026

Related U.S. Application Data
(60) Provisional application No. 63/804,980, filed on May 13, 2025.

(51) Int. Cl. B60R 9/06; B60D 1/52

(52) U.S. Cl. CPC B60R 9/06; B60D 1/52

(57) ABSTRACT

A pass-through trailer hitch extension is provided. The pass-through trailer hitch extension includes a male hitch connection configured to attach to a vehicle hitch connection, a support beam extending from the male hitch connection, a connection element carried by the support beam and configured to connect to a complementary accessory, and a female hitch connection disposed at an opposite end of the support beam from the male hitch connection. The female hitch connection is configured to operably couple to a male hitch connection of another pass-through trailer hitch extension. A trailer hitch extension system includes a first pass-through trailer hitch extension, a first complementary accessory connected to a first connection element, and a second pass-through trailer hitch extension operably coupled with a first female hitch connection. A method includes attaching, connecting, and coupling the pass-through trailer hitch extensions and the complementary accessory.

### RELATED APPLICATIONS

This application claims the benefit of U.S. Provisional Application No. 63/804,980, filed May 13, 2025, the entire contents of which are incorporated herein by reference.

### TECHNICAL FIELD

The disclosure relates to vehicle utility hitch accessories and, more particularly, to pass-through trailer hitch extensions for complementary accessories.

### BACKGROUND

Vehicle utility hitches are commonly used with trucks, sport utility vehicles, recreational vehicles, and other vehicles for towing and for carrying equipment outside the passenger compartment. At outdoor events, camping areas, worksites, and similar locations, users may also bring portable items such as seating, tables, cooking equipment, shade structures, coolers, audio equipment, and cargo carriers. These items can occupy substantial space in backseats, trunks, cargo areas, and truck beds, particularly when multiple passengers, luggage, tools, or other supplies are also being transported.

Many vehicle-mounted utility arrangements are configured for a particular task or item. For example, a hitch-mounted carrier may be arranged to carry cargo, while another hitch-mounted article may be arranged for a different recreational or utility purpose. As the number and variety of items used around a vehicle increases, coordinating transport, setup, spacing, and storage of those items can become cumbersome. In addition, loads positioned rearward of a vehicle can create handling, clearance, and stability considerations that vary depending on the vehicle, the ground surface, and the weight and location of the carried items.

### SUMMARY

In general, the disclosure describes a pass-through trailer hitch extension and a trailer hitch extension system for connecting complementary accessories to a vehicle hitch connection while permitting another pass-through trailer hitch extension to be operably coupled in series. The pass-through trailer hitch extension includes a male hitch connection configured to attach to a vehicle hitch connection, a support beam extending from the male hitch connection, a connection element carried by the support beam and configured to connect to a complementary accessory, and a female hitch connection disposed at an opposite end of the support beam from the male hitch connection and configured to operably couple to a male hitch connection of another pass-through trailer hitch extension. The disclosure also describes a method of assembling a trailer hitch extension system by attaching a male hitch connection of a first pass-through trailer hitch extension to a vehicle hitch connection, connecting a complementary accessory to a connection element carried by a support beam of the first pass-through trailer hitch extension, and coupling a male hitch connection of a second pass-through trailer hitch extension to a female hitch connection of the first pass-through trailer hitch extension.

The techniques of this disclosure may provide one or more advantages. For example, the pass-through trailer hitch extension can allow users to connect multiple extensions together while also connecting one or more complementary accessories. By using the male hitch connection and the female hitch connection at opposite ends of the support beam, the trailer hitch extension system may provide modular connectivity. By using the connection element carried by the support beam, the system may support a first complementary accessory, a second complementary accessory, or different complementary accessories, such as a chair, a table, a grill, a cooler, a cargo rack, a speaker, or an umbrella. In some examples, a support leg or an accessory leg extending downwardly to engage a ground surface may provide additional support during use. In some examples, a proximal section, a medial section, and a distal section of the support beam may position a complementary accessory at a selected height, and a strengthening rib may provide support adjacent a corner defined by the medial section and one of the proximal section or the distal section.

In one example, the disclosure is directed to a pass-through trailer hitch extension comprising a male hitch connection configured to attach to a vehicle hitch connection, a support beam extending from the male hitch connection, a connection element carried by the support beam and configured to connect to a complementary accessory, and a female hitch connection disposed at an opposite end of the support beam from the male hitch connection and configured to operably couple to a male hitch connection of another pass-through trailer hitch extension. The pass-through trailer hitch extension may further comprise a support leg extending downwardly from the support beam and configured to engage a ground surface. The connection element may be located on a top side of the support beam. The connection element may comprise a flange having connection holes. The connection element may comprise a clamp. The support beam may comprise a straight square tube. The support beam may comprise a proximal section, a medial section, and a distal section. The medial section may extend away from the proximal section at an angle. The medial section may extend away from the proximal section at a downward angle such that the distal section is positioned at a height lower than the proximal section. The pass-through trailer hitch extension may further comprise a strengthening rib, wherein the strengthening rib is disposed adjacent a corner defined by the medial section and one of the proximal section or the distal section.

In another example, the disclosure is directed to a trailer hitch extension system comprising a first pass-through trailer hitch extension comprising a first male hitch connection, a first support beam extending from the first male hitch connection, a first connection element carried by the first support beam, and a first female hitch connection disposed at an opposite end of the first support beam from the first male hitch connection. The trailer hitch extension system further comprises a first complementary accessory connected to the first connection element and a second pass-through trailer hitch extension comprising a second male hitch connection operably coupled with the first female hitch connection, a second support beam extending from the second male hitch connection, a second connection element carried by the second support beam, and a second female hitch connection disposed at an opposite end of the second support beam from the second male hitch connection. The trailer hitch extension system may further comprise a second complementary accessory connected to the second connection element. The second complementary accessory may be different from the first complementary accessory. At least one of the first complementary accessory and the second complementary accessory may comprise a chair, a table, a grill, a cooler, a cargo rack, a speaker, or an umbrella. The first pass-through trailer hitch extension may comprise a support leg extending downwardly from the first support beam and configured to engage a ground surface. The first complementary accessory may comprise an accessory leg extending downwardly from the first complementary accessory and configured to engage a ground surface.

In another example, the disclosure is directed to a method of assembling a trailer hitch extension system. The method comprises attaching a male hitch connection of a first pass-through trailer hitch extension to a vehicle hitch connection, connecting a complementary accessory to a connection element carried by a support beam of the first pass-through trailer hitch extension, and coupling a male hitch connection of a second pass-through trailer hitch extension to a female hitch connection of the first pass-through trailer hitch extension. The method may further comprise unfolding the complementary accessory from a transportation configuration to a usable configuration. The method may further comprise securing the male hitch connection of the first pass-through trailer hitch extension to the vehicle hitch connection with a removable pin. The method may further comprise inserting a pin through opposing holes formed in the female hitch connection of the first pass-through trailer hitch extension to secure the second pass-through trailer hitch extension to the first pass-through trailer hitch extension.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a perspective view illustrating an example pass-through trailer hitch extension, in accordance with the techniques described herein.

FIG. 2 is a perspective view illustrating an example trailer hitch extension system including multiple pass-through trailer hitch extensions, in accordance with the techniques described herein.

FIG. 3 is a side view illustrating an example pass-through trailer hitch extension, in accordance with the techniques described herein.

FIG. 4 is a front view illustrating an example complementary accessory in a transportation configuration, in accordance with the techniques described herein.

FIG. 5 is a front view illustrating an example complementary accessory in a usable configuration, in accordance with the techniques described herein.

FIG. 6 is a side view illustrating an example pass-through trailer hitch extension having a support leg engaging a ground surface, in accordance with the techniques described herein.

FIG. 7A-7F are perspective views illustrating example configurations of a complementary accessory between transportation and usable configurations, in accordance with the techniques described herein.

FIG. 8 is a perspective view illustrating an example trailer hitch extension system including multiple complementary accessories, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

The disclosure relates to a modular pass-through trailer hitch extension system that enables multiple vehicle hitch-mounted accessories to be attached in series while maintaining the ability to connect additional hitch extensions. The pass-through trailer hitch extension includes a male hitch connection for attachment to a vehicle hitch connection, a support beam extending from the male hitch connection, a connection element carried by the support beam for engaging a complementary accessory, and a female hitch connection at an opposite end of the support beam for receiving a male hitch connection of another pass-through trailer hitch extension.

The pass-through configuration allows a user to build a customized hitch-mounted arrangement by coupling multiple extensions together and attaching different complementary accessories to respective extensions. The complementary accessories may include, for example, chairs, tables, grills, coolers, cargo racks, speakers, umbrellas, and other vehicle-associated recreational or utility accessories. In this manner, the system addresses limitations of conventional single-purpose hitch accessories by allowing different accessories to be intermixed, rearranged, transported, and used in a modular configuration.

In some examples, the support beam may be formed as a straight square tube or may include proximal, medial, and distal sections. The medial section may extend at an angle relative to the proximal section, including a downward angle, an upward angle, or a straight configuration, to position attached accessories at selected heights based on user preference, vehicle hitch height, ground clearance, or accessory type. The extension may also be reversible so that angled extensions can be arranged to raise or lower successive accessories. Strengthening ribs may be provided at corners or angled portions of the support beam to increase structural strength.

The system may include structural support features for improving stability during use. For example, a support leg may extend downwardly from the support beam to engage the ground, or a support leg may extend downwardly from the complementary accessory itself. These support legs may reduce stress on the hitch extension and vehicle frame, particularly when accessories are positioned rearwardly from the vehicle or when heavier loads create increased torque or moment arms.

The disclosure also includes accessories that may transition between transportation and usable configurations. For example, a chair accessory may fold into a reduced-footprint configuration for travel and unfold into a usable seating configuration at an event site, optionally with legs extending downwardly for additional support. Overall, the disclosed system provides a flexible, stable, and user-configurable solution for expanding the functionality of a vehicle hitch in recreational, commercial, and other applications.

Conventional trailer hitch arrangements may provide limited flexibility when a user seeks to support multiple accessories, expand a hitch-mounted setup, or arrange different accessories in a selected sequence. A hitch arrangement configured for a single accessory or a single downstream connection may restrict the ability to combine chairs, tables, grills, coolers, cargo racks, speakers, umbrellas, or other accessories in a stable and adaptable manner. Additional technical challenges may arise when accessories are positioned at different distances from a vehicle hitch connection, including increased loading, increased moment arms, reduced stability, and the need to accommodate different vehicle hitch heights and different accessory use positions.

The disclosed technology addresses these challenges using a pass-through trailer hitch extension architecture that can both support an accessory and provide a further hitch connection for another extension. In general, a support beam extends between a vehicle-side hitch connection and an opposite hitch connection, and the support beam carries a connection element for securing a complementary accessory. This pass-through arrangement permits multiple extensions to be coupled in series so that different accessories can be combined in a modular configuration without eliminating the ability to add another extension. The extension may also include, or cooperate with an accessory that includes, a ground-engaging support leg to increase stability and reduce loading transmitted through the hitch connection.

The support beam may be configured to position accessories at selected heights or orientations while maintaining modular connectivity. For example, the support beam may be straight or may include sections arranged at an upward, downward, or otherwise selected angle to accommodate vehicle hitch height, accessory placement, ground clearance, or load distribution. Strengthening features may be provided near angled portions, and accessories may be movable between a transport configuration and a usable configuration. In this manner, the disclosed technology provides a flexible hitch-mounted platform that can be expanded, stabilized, and adapted for different accessory combinations and use environments.

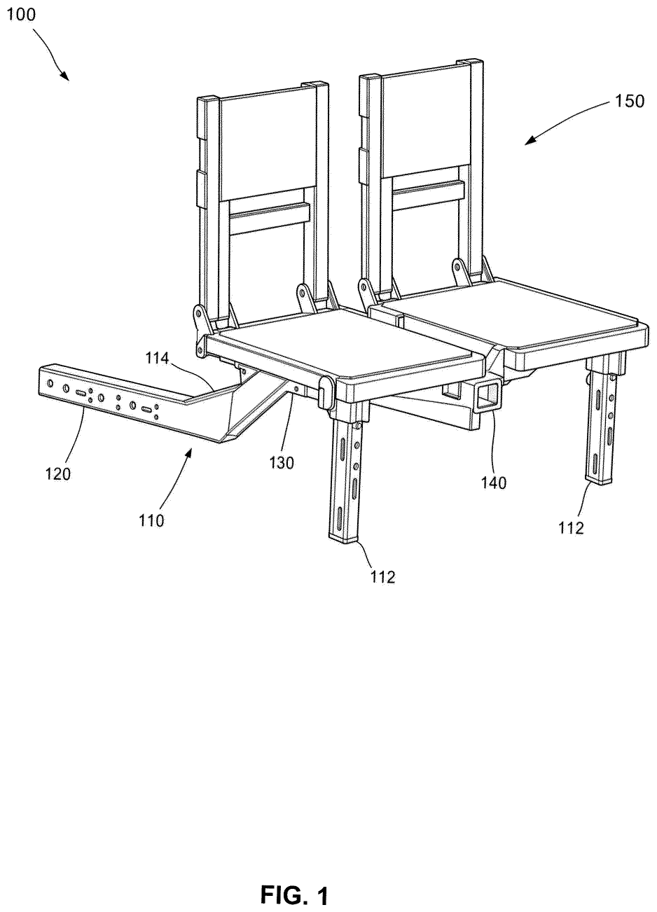

FIG. 1 is a perspective view of a pass-through trailer hitch extension 100, according to one embodiment. As shown in FIG. 1, pass-through trailer hitch extension 100 includes a male hitch connection 120, a support beam 130 extending from male hitch connection 120, a connection element 110 carried by support beam 130, and a female hitch connection 140 disposed at an opposite end of support beam 130 from male hitch connection 120. Pass-through trailer hitch extension 100 can further include a support leg 112 extending downwardly from support beam 130 and a strengthening rib 114 disposed adjacent a corner of support beam 130. In the illustrated embodiment, a complementary accessory 150 is connected to connection element 110 and is shown as a pair of chairs.

Male hitch connection 120 is configured to attach to a vehicle hitch connection. In some embodiments, male hitch connection 120 can be secured to the vehicle hitch connection with a removable pin. Support beam 130 extends away from male hitch connection 120 and serves as a structural element of pass-through trailer hitch extension 100. In the example of FIG. 1, support beam 130 includes a proximal section extending from male hitch connection 120, a medial section extending away from the proximal section at an angle, and a distal section positioned lower than the proximal section. In some embodiments, this angled configuration can position complementary accessory 150 relative to a height of the vehicle hitch connection.

In some examples, support beam 130 may be arranged in different orientations to selectively raise or lower a downstream portion of pass-through trailer hitch extension 100. For example, an angled support beam 130 may be installed in a first orientation in which a distal section of support beam 130 is lower than a proximal section of support beam 130, or in a second orientation in which the distal section is higher than the proximal section. The first orientation may position complementary accessory 150 closer to the ground surface or may reduce a height of a downstream pass-through trailer hitch extension. The second orientation may increase ground clearance, raise complementary accessory 150, or position a downstream pass-through trailer hitch extension at a greater height. In some embodiments, male hitch connection 120 and female hitch connection 140 may be configured so that a selected angled orientation can be used while maintaining the pass-through coupling between adjacent pass-through trailer hitch extensions.

Connection element 110 is carried by support beam 130 and is configured to connect to complementary accessory 150. In some embodiments, connection element 110 can be located on a top side of support beam 130. Connection element 110 can include a flange having connection holes, a clamp, or another connection apparatus suitable for connecting complementary accessory 150 to support beam 130. Complementary accessory 150 can include a chair, a table, a grill, a cooler, a cargo rack, a speaker, an umbrella, or another accessory. In the illustrated embodiment, complementary accessory 150 comprises chairs supported relative to support beam 130 by connection element 110.

In some examples, the connection element 110 may include one or more mechanical interface structures configured to secure the complementary accessory 150 to the support beam 130. For example, the connection element 110 may include one or more bolts, pins, brackets, sleeves, collars, clamps, receivers, fasteners, quick-release couplers, or accessory-specific mounting plates. In some examples, the connection element 110 may be fixed to the support beam 130 by welding, by threaded fasteners, or by an interference fit, or may be removably coupled to the support beam 130 to permit replacement with another connection element 110 configured for a different complementary accessory 150. In some examples, the complementary accessory 150 may include a mating structure configured to engage the connection element 110, such as a plate having holes aligned with holes of the connection element 110, a sleeve or receiver configured to slide over or into a corresponding portion of the connection element 110, or a bracket configured to be clamped, pinned, or bolted to the connection element 110.

Female hitch connection 140 is disposed at the opposite end of support beam 130 from male hitch connection 120 and is configured to operably couple to a male hitch connection of another pass-through trailer hitch extension. Female hitch connection 140 can include opposing holes configured to receive a pin to secure another pass-through trailer hitch extension to pass-through trailer hitch extension 100. In this manner, pass-through trailer hitch extension 100 can permit multiple pass-through trailer hitch extensions to be operably coupled in series while supporting one or more complementary accessories.

Male hitch connection 120 may be configured for insertion into, around, or otherwise engagement with a corresponding vehicle hitch connection. In some embodiments, male hitch connection 120 may comprise a tube, bar, shank, sleeve, adapter, or receiver-compatible member having one or more holes configured to align with corresponding holes of the vehicle hitch connection. A removable pin, locking pin, threaded fastener, latch, or other retention member may extend through the aligned holes to restrict withdrawal of male hitch connection 120 from the vehicle hitch connection. Female hitch connection 140 may similarly comprise a receiver, sleeve, tube, collar, bracket, or other receiving structure configured to receive a male hitch connection of another pass-through trailer hitch extension. In some embodiments, female hitch connection 140 may include opposing holes configured to align with holes of the received male hitch connection so that a removable pin, locking pin, threaded fastener, latch, or other retention member secures the received male hitch connection relative to female hitch connection 140. In some examples, adapters or bushings may be used with male hitch connection 120 or female hitch connection 140 to accommodate different hitch sizes, cross-sectional shapes, or tolerances.

Support leg 112 can extend downwardly from support beam 130 and can be configured to engage a ground surface. Where present, support leg 112 can provide support to pass-through trailer hitch extension 100 and complementary accessory 150. In some embodiments, an accessory leg can extend downwardly from complementary accessory 150 and be configured to engage the ground surface. Strengthening rib 114 can be disposed adjacent a corner defined by the medial section and one of the proximal section or the distal section of support beam 130, thereby reinforcing support beam 130 at the angled portion of pass-through trailer hitch extension 100.

Support leg 112 may be adjustable to accommodate different vehicle hitch heights, ground clearances, accessory loads, or ground surface conditions. In some embodiments, support leg 112 may include telescoping leg sections, a threaded adjustment member, a locking pin, a detent, a clamp, or another adjustment mechanism configured to selectively set a length of support leg 112. Support leg 112 may include a foot, pad, plate, wheel, caster, or ground-engaging member at a lower end of support leg 112 to distribute load over the ground surface. In some embodiments, support leg 112 may be pivotable, removable, foldable, or otherwise movable between a deployed configuration in which support leg 112 engages the ground surface and a stowed configuration in which support leg 112 is positioned closer to support beam 130 for transportation or storage.

When a complementary accessory 150 is positioned rearwardly from the vehicle hitch connection, weight of complementary accessory 150 and any load applied to complementary accessory 150 may create a moment about the vehicle hitch connection. Support leg 112, an accessory leg, or a combination thereof may transfer at least a portion of the applied load to the ground surface and may thereby reduce bending loads transmitted through support beam 130, male hitch connection 120, female hitch connection 140, or the vehicle hitch connection. In some embodiments, support beam 130, strengthening rib 114, support leg 112, and connection element 110 may be selected or arranged based on an expected accessory type, expected user-applied load, spacing between adjacent pass-through trailer hitch extensions, or a distance between the vehicle hitch connection and complementary accessory 150.

A real-life implementation of the disclosed system can be used at a tailgating site, campsite, worksite, or other location where a vehicle is parked and multiple accessories are used outside the vehicle. In one example, a user positions a vehicle having a vehicle hitch connection at a selected location and attaches a male hitch connection 120 of a first pass-through trailer hitch extension 100 to the vehicle hitch connection. The male hitch connection 120 can be inserted into the vehicle hitch connection and secured using a removable pin 122. A support beam 130 extends rearwardly from the male hitch connection 120 and carries a female hitch connection 140 configured to connect to a complementary accessory 150. The user can attach the complementary accessory 150, such as a chair, table, grill, cooler, cargo rack, one or more speakers, or umbrella, to the female hitch connection 140 so that the complementary accessory 150 is supported relative to the support beam 130.

After the first pass-through trailer hitch extension 100 is attached to the vehicle, the user can attach a second pass-through trailer hitch extension 200 to a female hitch connection 114 of the first pass-through trailer hitch extension 100. For example, a male hitch connection of the second pass-through trailer hitch extension 200 can be received in the female hitch connection 114 and secured with a pin extending through aligned holes. The second pass-through trailer hitch extension 200 can carry another connection element for supporting a second complementary accessory that is the same as or different from the complementary accessory 150. In this way, the user can assemble a modular arrangement in which different accessories are positioned in series behind the vehicle while the pass-through structure remains available for adding one or more additional pass-through trailer hitch extensions.

In some examples, the support beam 130 of one or more pass-through trailer hitch extensions can be straight, upwardly angled, or downwardly angled to locate the associated complementary accessory 150 at a selected height relative to the vehicle hitch connection and a ground surface. A support leg 112 can extend downwardly from the support beam 130 to engage the ground surface and provide additional support. Additionally or alternatively, the complementary accessory 150 can include an accessory leg that extends downwardly to engage the ground surface. Where the complementary accessory 150 is a chair or another foldable article, the complementary accessory 150 can be transported in a reduced-footprint transportation configuration and then moved to a usable configuration after the pass-through trailer hitch extension 100 is attached to the vehicle.

For example, at a sporting event, a first pass-through trailer hitch extension 100 can support a table accessory, a second pass-through trailer hitch extension 200 can support a chair accessory, and a third pass-through trailer hitch extension can support an umbrella or one or more speakers. At a worksite, a first pass-through trailer hitch extension 100 can support a cargo rack or tool-supporting accessory, while another pass-through trailer hitch extension supports a table or other work surface. As a result, the same vehicle hitch connection can be used to build different accessory arrangements by selecting pass-through trailer hitch extensions and complementary accessories according to the intended use environment.

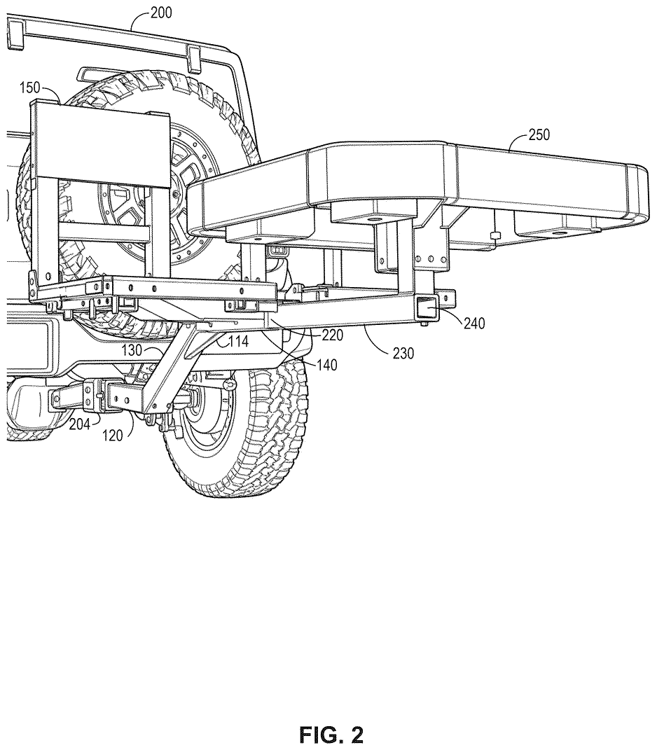

FIG. 2 is a perspective view illustrating an example trailer hitch extension system including a first pass-through trailer hitch extension attached to a vehicle hitch connection 204 and a second pass-through trailer hitch extension operably coupled with the first pass-through trailer hitch extension. In the example of FIG. 2, the vehicle hitch connection 204 is supported relative to a vehicle frame 200. The first pass-through trailer hitch extension includes a male hitch connection 120, a support beam 130 extending from the male hitch connection 120, a strengthening rib 114, a female hitch connection 140 disposed at an opposite end of the support beam 130 from the male hitch connection 120, and a complementary accessory 150. The second pass-through trailer hitch extension includes a male hitch connection 220, a support beam 230 extending from the male hitch connection 220, a female hitch connection 240 disposed at an opposite end of the support beam 230 from the male hitch connection 220, and a table accessory 250.

As shown in the example of FIG. 2, the male hitch connection 120 of the first pass-through trailer hitch extension may be configured to attach to the vehicle hitch connection 204. The vehicle hitch connection 204 may be carried by, connected to, or otherwise supported relative to the vehicle frame 200 such that the first pass-through trailer hitch extension extends away from the vehicle frame 200. In some examples, the male hitch connection 120 may be secured to the vehicle hitch connection 204 with a removable pin. The support beam 130 may extend away from the male hitch connection 120 to carry the complementary accessory 150 and to position the female hitch connection 140 at the opposite end of the support beam 130 from the male hitch connection 120.

In accordance with techniques of the disclosure, the female hitch connection 140 of the first pass-through trailer hitch extension may be configured to operably couple to the male hitch connection 220 of the second pass-through trailer hitch extension. For example, the male hitch connection 220 may be received by the female hitch connection 140 to arrange the first pass-through trailer hitch extension and the second pass-through trailer hitch extension in series. In some examples, a pin may be inserted through opposing holes formed in the female hitch connection 140 to secure the male hitch connection 220 to the female hitch connection 140. The support beam 230 of the second pass-through trailer hitch extension may extend from the male hitch connection 220 to the female hitch connection 240 so that another pass-through trailer hitch extension may be operably coupled with the female hitch connection 240.

The complementary accessory 150 may be connected to a connection element carried by the support beam 130. In some examples, the connection element may be located on a top side of the support beam 130. The connection element may comprise a flange having connection holes, a clamp, or another connection apparatus suitable for connecting the complementary accessory 150 to the support beam 130. The complementary accessory 150 may comprise a chair, a table, a grill, a cooler, a cargo rack, a speaker, an umbrella, or another accessory. Although FIG. 2 shows the complementary accessory 150 connected to the first pass-through trailer hitch extension, in other examples a different complementary accessory may be connected to the first pass-through trailer hitch extension.

The table accessory 250 may be connected to a connection element carried by the support beam 230 of the second pass-through trailer hitch extension. The table accessory 250 may be an example of a second complementary accessory that is different from the complementary accessory 150 connected to the first pass-through trailer hitch extension. In some examples, the table accessory 250 may be unfolded from a transportation configuration to a usable configuration when the trailer hitch extension system is assembled for use. Although shown as a table accessory 250, the second complementary accessory may comprise a chair, a grill, a cooler, a cargo rack, a speaker, an umbrella, or another accessory.

The strengthening rib 114 may be disposed adjacent a corner defined by portions of the support beam 130. In some examples, the support beam 130 may comprise a proximal section, a medial section, and a distal section, and the medial section may extend away from the proximal section at a downward angle such that the distal section is positioned at a height lower than the proximal section. The strengthening rib 114 may be positioned adjacent a corner defined by the medial section and one of the proximal section or the distal section. In other examples, the support beam 130 and the support beam 230 may each comprise a straight square tube, or may include other shapes or angular arrangements suitable for positioning the complementary accessory 150 and the table accessory 250 relative to the vehicle frame 200.

In some examples, the arrangement shown in FIG. 2 enables the first pass-through trailer hitch extension and the second pass-through trailer hitch extension to support different complementary accessories while preserving a female hitch connection 240 for another pass-through trailer hitch extension. The trailer hitch extension system may thereby allow multiple pass-through trailer hitch extensions to be operably coupled in series in selected combinations of complementary accessories.

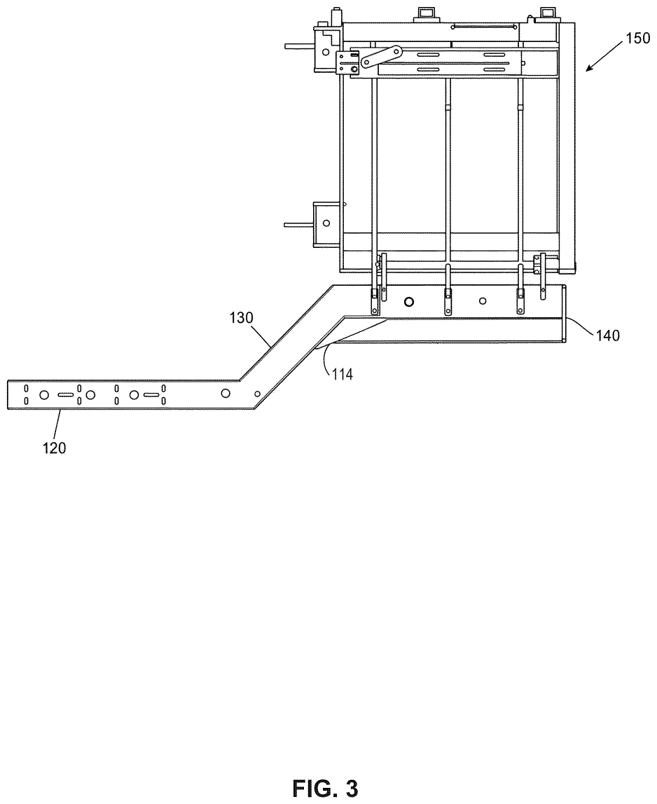

FIG. 3 is a side view of a pass-through trailer hitch extension, in accordance with one or more embodiments of this disclosure. As shown in FIG. 3, the pass-through trailer hitch extension includes a male hitch connection 120, a support beam 130 extending from the male hitch connection 120, a female hitch connection 140 disposed at an opposite end of the support beam 130 from the male hitch connection 120, a strengthening rib 114, and a complementary accessory 150 connected relative to the support beam 130. In the example of FIG. 3, the complementary accessory 150 is shown in a usable configuration and is supported above the support beam 130.

The male hitch connection 120 may be configured to attach to a vehicle hitch connection. In some embodiments, the male hitch connection 120 may include holes configured to receive a removable pin to secure the male hitch connection 120 to the vehicle hitch connection. The support beam 130 extends away from the male hitch connection 120 and serves as a structural member that carries a connection element configured to connect to the complementary accessory 150. In the example of FIG. 3, the support beam 130 includes a proximal section extending from the male hitch connection 120, a medial section extending away from the proximal section at an angle, and a distal section positioned adjacent the female hitch connection 140.

In accordance with techniques of the disclosure, the medial section of the support beam 130 may extend away from the proximal section at a downward angle such that the distal section is positioned at a height lower than the proximal section. The angled configuration may allow the complementary accessory 150 to be positioned based on a height of the vehicle hitch connection and may improve usability of the complementary accessory 150. In some embodiments, the support beam 130 may comprise a straight square tube, while in other embodiments, the support beam 130 may include the proximal section, the medial section, and the distal section shown in FIG. 3.

The strengthening rib 114 may be disposed adjacent a corner defined by the medial section and the distal section of the support beam 130. In some examples, the strengthening rib 114 may increase strength at the corner or angle of the support beam 130. Although a single strengthening rib 114 is shown in FIG. 3, in other examples, one or more strengthening ribs may be provided adjacent one or more corners or angles of the support beam 130.

The female hitch connection 140 may be disposed at the opposite end of the support beam 130 from the male hitch connection 120 and may be configured to operably couple to a male hitch connection of another pass-through trailer hitch extension. In some embodiments, the female hitch connection 140 may include opposing holes configured to receive a pin to secure the other pass-through trailer hitch extension to the pass-through trailer hitch extension shown in FIG. 3. The complementary accessory 150 may comprise, for example, a chair, a table, a grill, a cooler, a cargo rack, a speaker, or an umbrella. In some examples, the complementary accessory 150 may be connected to the connection element carried by the support beam 130 and may be folded from a transportation configuration to the usable configuration shown in FIG. 3.

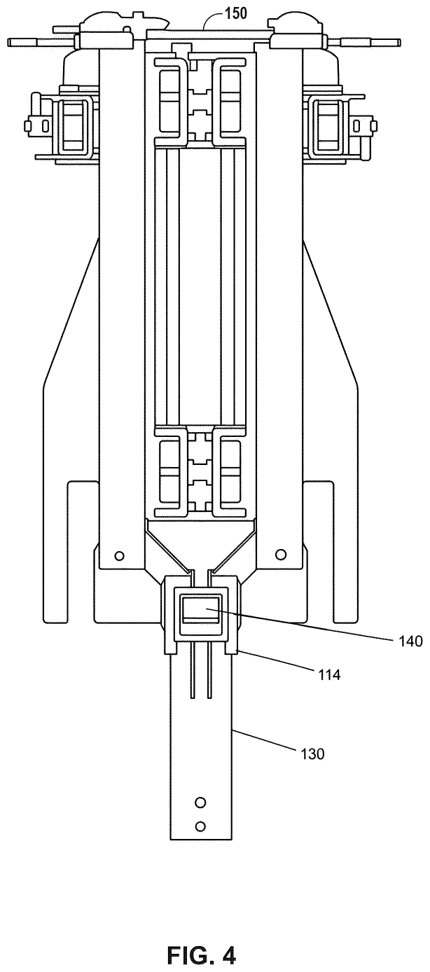

FIG. 4 is a front view of an embodiment of a pass-through trailer hitch extension in which complementary accessory 150 is in a transportation configuration. In the example of FIG. 4, support beam 130 extends along a central portion of the pass-through trailer hitch extension, female hitch connection 140 is disposed at an end of support beam 130, strengthening rib 114 is disposed adjacent female hitch connection 140, and complementary accessory 150 is positioned above support beam 130.

Support beam 130 can serve as a main structural element of the pass-through trailer hitch extension and can carry a connection element configured to connect to complementary accessory 150. Although the connection element is at least partially obscured in the front view of FIG. 4, complementary accessory 150 is shown in a folded arrangement relative to support beam 130. In some embodiments, complementary accessory 150 may be unfolded from the transportation configuration shown in FIG. 4 to a usable configuration at an event site.

Female hitch connection 140 is disposed at an opposite end of support beam 130 from a male hitch connection and is configured to operably couple to a male hitch connection of another pass-through trailer hitch extension. Female hitch connection 140 may include opposing holes formed in the female hitch connection to receive a pin for securing the other pass-through trailer hitch extension to the pass-through trailer hitch extension. In this manner, the pass-through trailer hitch extension may enable multiple extensions to be operably coupled in series while complementary accessory 150 remains connected to the pass-through trailer hitch extension.

Strengthening rib 114 is disposed adjacent a corner of support beam 130 near female hitch connection 140. Strengthening rib 114 may increase the strength of the pass-through trailer hitch extension at the corner, including in embodiments in which support beam 130 includes a proximal section, a medial section extending away from the proximal section at an angle, and a distal section. In some examples, the medial section may extend away from the proximal section at a downward angle such that the distal section is positioned at a height lower than the proximal section, and strengthening rib 114 may be disposed adjacent a corner defined by the medial section and one of the proximal section or the distal section.

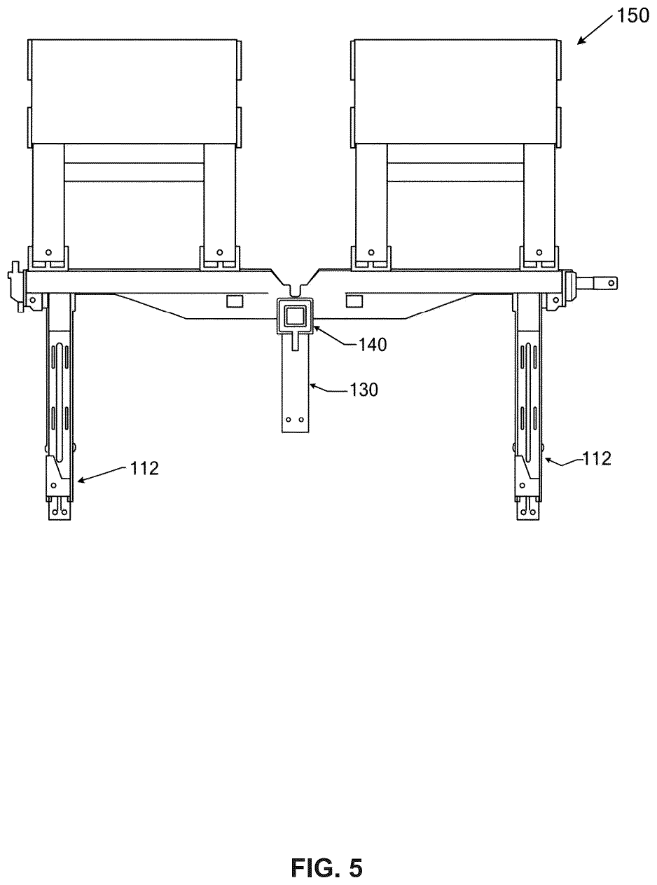

FIG. 5 is a front view of an embodiment of a pass-through trailer hitch extension in a usable configuration. In the example of FIG. 5, the pass-through trailer hitch extension includes a support beam 130, a female hitch connection 140 carried by the support beam 130, a complementary accessory 150 connected to the support beam 130, and support legs 112 extending downwardly relative to the support beam 130. The complementary accessory 150 is shown in the usable configuration and may comprise, for example, a chair, a table, a grill, a cooler, a cargo rack, a speaker, an umbrella, or another accessory configured for connection to the pass-through trailer hitch extension.

As shown in FIG. 5, the support beam 130 extends laterally across the front view and serves as a structural member for supporting the complementary accessory 150. In some embodiments, the support beam 130 may comprise a straight square tube. In other embodiments, the support beam 130 may include a proximal section, a medial section, and a distal section, with the medial section extending away from the proximal section at an angle so that a portion of the support beam 130 is positioned at a selected height for the complementary accessory 150. The complementary accessory 150 is connected to a connection element carried by the support beam 130, although the connection element is at least partially obscured by the complementary accessory 150 in the front view of FIG. 5.

The female hitch connection 140 is disposed at an opposite end of the support beam 130 from a male hitch connection and is configured to operably couple to a male hitch connection of another pass-through trailer hitch extension. In the front view of FIG. 5, the female hitch connection 140 is positioned near a central portion of the illustrated assembly and presents an opening for receiving the male hitch connection of another pass-through trailer hitch extension. In some embodiments, opposing holes formed in the female hitch connection 140 may receive a pin to secure another pass-through trailer hitch extension to the pass-through trailer hitch extension shown in FIG. 5.

Support legs 112 may extend downwardly from the support beam 130 and may be configured to engage a ground surface. In some embodiments, support legs 112 provide additional structural reinforcement for the support beam 130 and the complementary accessory 150 when the complementary accessory 150 is in the usable configuration. The support legs 112 may be optional, and in other embodiments an accessory leg may extend downwardly from the complementary accessory 150 to engage the ground surface and provide localized support.

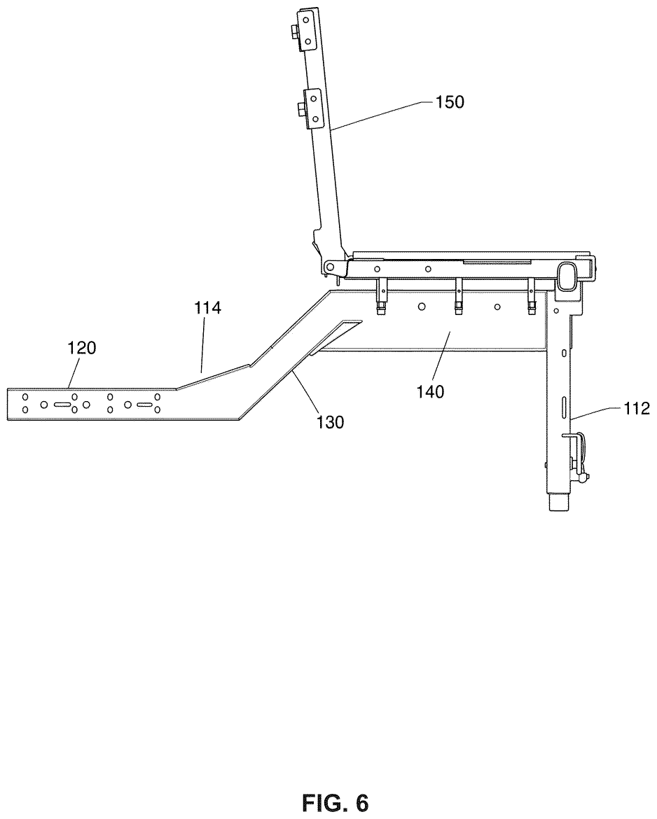

As shown in the example of FIG. 6, a pass-through trailer hitch extension includes a male hitch connection 120, a support beam 130 extending from the male hitch connection 120, a female hitch connection 140 disposed at an opposite end of the support beam 130 from the male hitch connection 120, a support leg 112, a strengthening rib 114, and a complementary accessory 150. FIG. 6 illustrates an embodiment in which the support beam 130 includes an angled configuration and the support leg 112 extends downwardly from the support beam 130 toward a ground surface.

In accordance with the techniques described herein, the male hitch connection 120 can be configured to attach to a vehicle hitch connection. The support beam 130 can extend from the male hitch connection 120 and can serve as a main structural element for carrying a connection element configured to connect to the complementary accessory 150. The female hitch connection 140 can be disposed at the opposite end of the support beam 130 from the male hitch connection 120 and can be configured to operably couple to a male hitch connection of another pass-through trailer hitch extension, thereby permitting multiple pass-through trailer hitch extensions to be operably coupled in series.

In the example of FIG. 6, the support beam 130 includes a proximal section extending from the male hitch connection 120, a medial section extending away from the proximal section at an angle, and a distal section positioned adjacent the female hitch connection 140. The medial section can extend away from the proximal section at a downward angle such that the distal section is positioned at a height lower than the proximal section. In some examples, this configuration can position the complementary accessory 150 relative to a height of the vehicle hitch connection and can affect load distribution along the pass-through trailer hitch extension.

The strengthening rib 114 can be disposed adjacent a corner defined by the medial section and one of the proximal section or the distal section. In some examples, the strengthening rib 114 can increase the strength of the pass-through trailer hitch extension at the corner or angle of the support beam 130. Although FIG. 6 shows the strengthening rib 114 along the angled portion of the support beam 130, other embodiments can include additional strengthening ribs or can omit the strengthening rib 114.

The support leg 112 can extend downwardly from the support beam 130 and can be configured to engage the ground surface. Where present, the support leg 112 can provide additional structural support to the pass-through trailer hitch extension and the complementary accessory 150. In other examples, a support leg can extend downwardly from the complementary accessory 150 itself, or the support leg 112 can be omitted.

The complementary accessory 150 can be connected to the connection element carried by the support beam 130. The complementary accessory 150 can comprise a chair, a table, a grill, a cooler, a cargo rack, a speaker, an umbrella, or another accessory. In some examples, the complementary accessory 150 can be configured to move between a transportation configuration and a usable configuration while remaining connectable to the connection element of the pass-through trailer hitch extension.

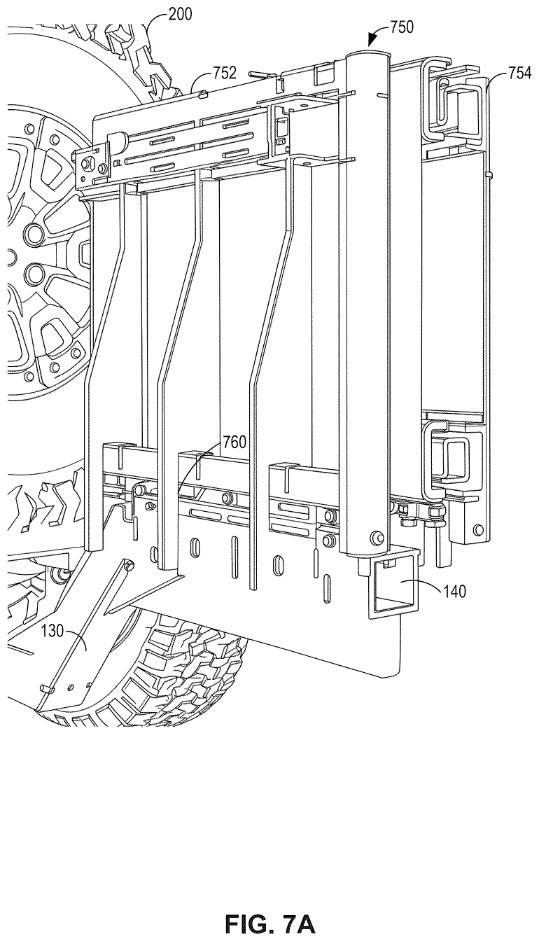

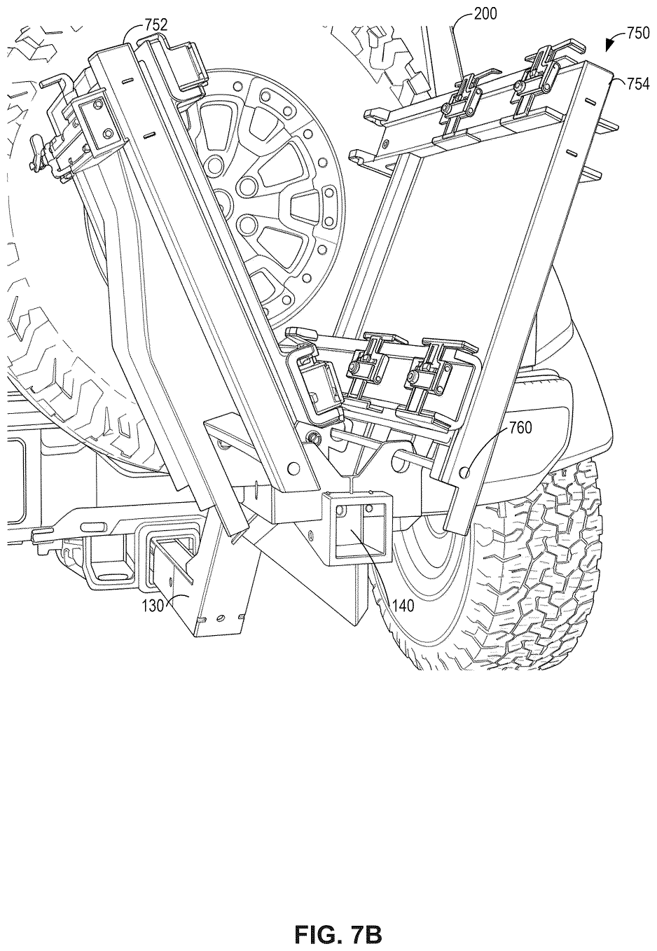

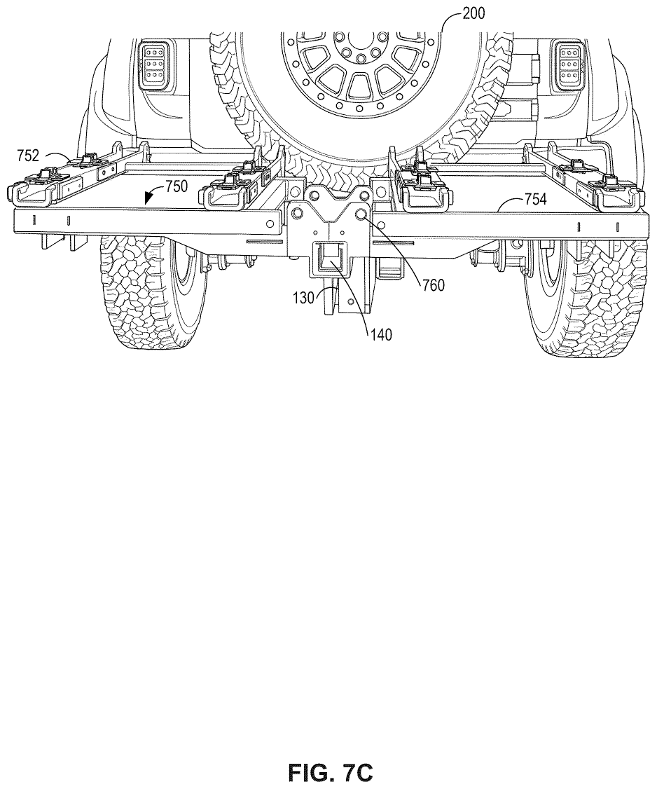

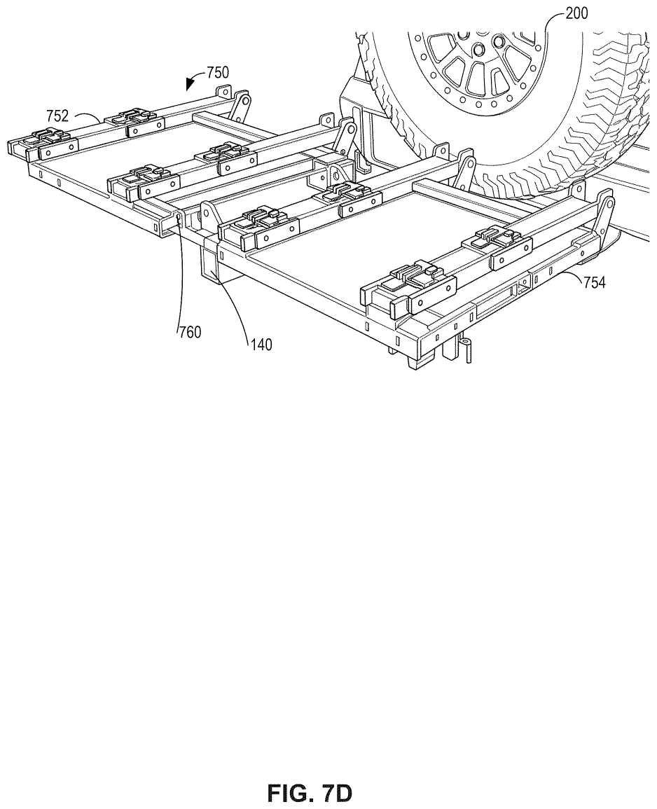

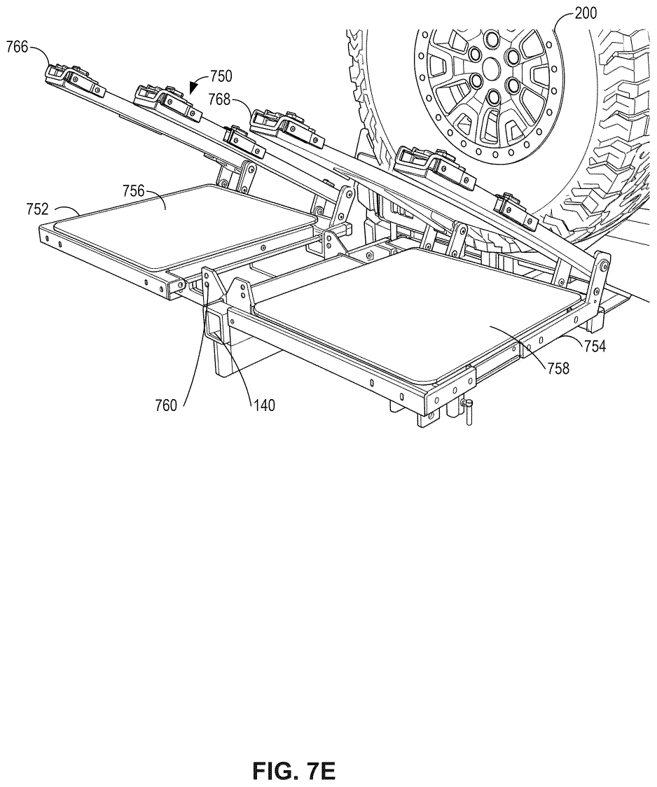

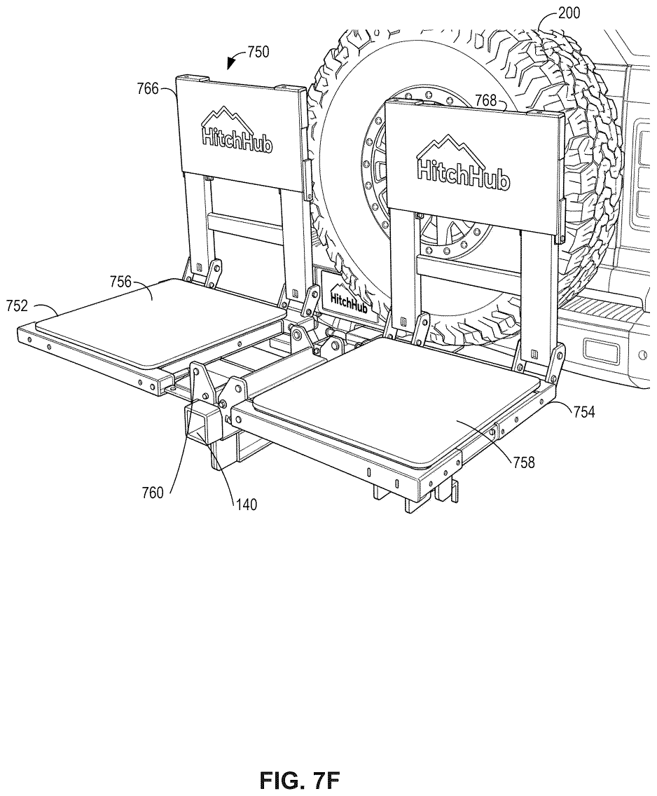

FIG. 7A shows an example of a pass-through trailer hitch extension in which a complementary accessory is configured as a folding chair set accessory 750 and is positioned relative to a vehicle frame 200. The folding chair set accessory 750 may be carried by or otherwise connected relative to a support beam 130 and may be arranged so that a female hitch connection 140 remains positioned for pass-through use. In the illustrated embodiment, the folding chair set accessory 750 includes a first chair 752 and a second chair 754, and one or more hinges 760 may permit movement of the first chair 752 and the second chair 754 between a transportation configuration and a usable configuration.

The folding chair set accessory 750 shown in FIG. 7A-7D is illustrated in various stages between folded and usable configurations. The first chair 752 and the second chair 754 may move relative to one another about the one or more hinges 760 so that the folding chair set accessory 750 can be reduced in footprint during travel and then unfolded at a use location. The support beam 130 may support the folding chair set accessory 750, and the female hitch connection 140 may remain accessible during at least some stages of deployment to operably couple to a male hitch connection of another pass-through trailer hitch extension or to another compatible hitch-mounted component.

The folding chair set accessory 750 shown in FIGS. 7E and 7F may include additional chair components associated with the first chair 752 and the second chair 754. The first chair 752 may include a first chair seat 756 and a first chair back 766, and the second chair 754 may include a second chair seat 758 and a second chair back 768. In some embodiments, the first chair back 766 and the second chair back 768 may fold relative to the first chair seat 756 and the second chair seat 758, respectively, to transition the folding chair set accessory 750 between the transportation configuration and the usable configuration. FIG. 7F shows the folding chair set accessory 750 in the usable configuration, with the first chair 752 and the second chair 754 deployed for seating.

In some examples, folding chair set accessory 750 may transition from a transportation configuration to a usable configuration through multiple intermediate positions. For example, first chair 752 and second chair 754 may initially be folded toward support beam 130 to reduce a footprint of folding chair set accessory 750 during travel. During deployment, first chair 752 and second chair 754 may pivot outwardly relative to support beam 130, and first chair back 766 and second chair back 768 may be raised relative to first chair seat 756 and second chair seat 758, respectively. FIG. 7E illustrates an intermediate deployment position in which first chair back 766 and second chair back 768 are being raised as part of placing folding chair set accessory 750 in the usable configuration. FIG. 7F illustrates an example usable configuration in which first chair back 766 and second chair back 768 extend upwardly relative to first chair seat 756 and second chair seat 758. One or more hinges 760, pivots, linkages, detents, locks, braces, or stops may be used to guide movement of folding chair set accessory 750 and to retain first chair 752 and second chair 754 in the transportation configuration, the usable configuration, or an intermediate position.

The folding chair set accessory 750 is one example of a complementary accessory and does not limit the pass-through trailer hitch extension to use with a chair. Other complementary accessories, including a table, a grill, a cooler, a cargo rack, a speaker, an umbrella, or another accessory may be connected to a connection element carried by the support beam 130. The vehicle frame 200 provides an example operating environment, and the female hitch connection 140 may preserve the ability of the pass-through trailer hitch extension to operably couple with another pass-through trailer hitch extension while supporting the complementary accessory.

As shown in FIG. 7A, a trailer hitch extension system includes a pass-through trailer hitch extension coupled with a vehicle frame 200 and carrying a folding chair set accessory 750. The folding chair set accessory 750 includes a first chair 752, a second chair 754, and a hinge 760. The pass-through trailer hitch extension includes a support beam 130 extending rearwardly from the vehicle frame 200 and a female hitch connection 140 disposed at an opposite end of the support beam 130 from a male hitch connection that is received by a vehicle hitch connection of the vehicle frame 200.

In accordance with techniques of the disclosure, the folding chair set accessory 750 may be connected to a connection element carried by the support beam 130. In the example of FIG. 7A, the folding chair set accessory 750 is shown in a transportation configuration in which the first chair 752 and the second chair 754 are folded and positioned adjacent to the support beam 130. The transportation configuration may reduce a footprint of the folding chair set accessory 750 while the pass-through trailer hitch extension is attached to the vehicle frame 200.

The first chair 752 may be positioned on a first side of the folding chair set accessory 750, and the second chair 754 may be positioned on a second side of the folding chair set accessory 750. The first chair 752 and the second chair 754 may be supported by portions of the folding chair set accessory 750 that extend generally transverse to the support beam 130 when the folding chair set accessory 750 is in the transportation configuration. The hinge 760 may enable at least one of the first chair 752 or the second chair 754 to move relative to another portion of the folding chair set accessory 750 during transition between the transportation configuration and a usable configuration.

The female hitch connection 140 is disposed at a distal portion of the support beam 130 and is configured to operably couple to a male hitch connection of another pass-through trailer hitch extension. The female hitch connection 140 may thereby allow an additional pass-through trailer hitch extension to be connected in series with the pass-through trailer hitch extension shown in FIG. 7A while the folding chair set accessory 750 remains connected to the support beam 130.

As shown in FIG. 7B, vehicle frame 200 supports a pass-through trailer hitch extension including support beam 130 and female hitch connection 140. Folding chair set accessory 750 is connected to the pass-through trailer hitch extension and includes first chair 752, second chair 754, and hinge 760. In the example of FIG. 7B, folding chair set accessory 750 is shown in a configuration between a transportation configuration and a usable configuration.

In accordance with techniques of the disclosure, support beam 130 may carry a connection element configured to connect to a complementary accessory, such as folding chair set accessory 750. Female hitch connection 140 is disposed at an opposite end of support beam 130 from a male hitch connection and is configured to operably couple to a male hitch connection of another pass-through trailer hitch extension. In some examples, female hitch connection 140 may include opposing holes formed in the female hitch connection to receive a pin for securing another pass-through trailer hitch extension to the pass-through trailer hitch extension.

Folding chair set accessory 750 may be selected as the complementary accessory connected to the connection element carried by support beam 130. First chair 752 and second chair 754 may be movable relative to support beam 130 and female hitch connection 140 as folding chair set accessory 750 transitions between the transportation configuration and the usable configuration. In some examples, first chair 752 and second chair 754 may fold to reduce a footprint of folding chair set accessory 750 while travelling and may unfold at an event site for use.

Hinge 760 may couple at least one of first chair 752 or second chair 754 to another portion of folding chair set accessory 750 such that the corresponding chair is movable between folded and unfolded positions. As illustrated in FIG. 7B, hinge 760 permits second chair 754 to pivot relative to the pass-through trailer hitch extension during movement of folding chair set accessory 750 between the transportation configuration and the usable configuration. In some examples, folding chair set accessory 750 may include additional hinges or pivoting connections to permit first chair 752 and second chair 754 to fold down onto respective seats and upwardly into one another.

As shown in FIG. 7C, a trailer hitch extension system can include a vehicle frame 200, a support beam 130, a female hitch connection 140, and a folding chair set accessory 750. Folding chair set accessory 750 can include a first chair 752, a second chair 754, and a hinge 760. FIG. 7C illustrates an embodiment in which folding chair set accessory 750 is connected to support beam 130 and arranged laterally across a rear portion of vehicle frame 200.

In accordance with techniques of the disclosure, support beam 130 can extend rearwardly from a vehicle hitch connection associated with vehicle frame 200 and can carry a connection element configured to connect to a complementary accessory. In the example of FIG. 7C, folding chair set accessory 750 is an example of the complementary accessory and can be supported by support beam 130. Female hitch connection 140 can be disposed at an opposite end of support beam 130 from a male hitch connection and can be configured to operably couple to a male hitch connection of another pass-through trailer hitch extension. In this arrangement, female hitch connection 140 remains accessible while folding chair set accessory 750 is connected to support beam 130, thereby permitting modular coupling of an additional pass-through trailer hitch extension.

Folding chair set accessory 750 can include first chair 752 and second chair 754 positioned on opposing lateral sides of support beam 130. First chair 752 and second chair 754 can be configured to move between a transportation configuration and a usable configuration. For example, first chair 752 and second chair 754 can fold relative to support beam 130 to reduce a footprint of folding chair set accessory 750 during transportation and can unfold relative to support beam 130 to provide seating in the usable configuration.

Hinge 760 can operably couple a portion of folding chair set accessory 750 to support beam 130 and can permit movement of at least a portion of folding chair set accessory 750 between the transportation configuration and the usable configuration. In some examples, hinge 760 can be positioned near a central portion of folding chair set accessory 750 adjacent support beam 130, such that first chair 752 and second chair 754 can be selectively positioned relative to vehicle frame 200. Although FIG. 7C illustrates folding chair set accessory 750, other complementary accessories can be connected to support beam 130 in other embodiments.

FIG. 7D is a perspective view of a folding chair set accessory 750 in a usable configuration with respect to a vehicle frame 200, according to one embodiment. In the example of FIG. 7D, folding chair set accessory 750 includes a first chair 752, a second chair 754, and a hinge 760. Female hitch connection 140 is positioned between first chair 752 and second chair 754 and remains available to operably couple to a male hitch connection of another pass-through trailer hitch extension.

As shown in FIG. 7D, folding chair set accessory 750 may be a complementary accessory connected to a connection element carried by a support beam of a pass-through trailer hitch extension. First chair 752 and second chair 754 may be arranged on opposing lateral sides of female hitch connection 140 such that the folding chair set accessory 750 provides multiple seating positions while preserving access to female hitch connection 140. In some embodiments, folding chair set accessory 750 may be selected as a first complementary accessory or a second complementary accessory in a trailer hitch extension system that includes multiple pass-through trailer hitch extensions operably coupled in series.

Hinge 760 may be coupled with at least a portion of folding chair set accessory 750 to enable movement of first chair 752 and/or second chair 754 between a transportation configuration and the usable configuration shown in FIG. 7D. For example, first chair 752 and second chair 754 may fold to reduce a footprint of folding chair set accessory 750 during transportation and may unfold at an event site for use. Where present, hinge 760 supports this transition without requiring removal of female hitch connection 140 or eliminating the ability of female hitch connection 140 to receive another pass-through trailer hitch extension.

In accordance with techniques of the disclosure, female hitch connection 140 may include opposing holes configured to receive a pin to secure a male hitch connection of another pass-through trailer hitch extension to the pass-through trailer hitch extension associated with folding chair set accessory 750. In this manner, the arrangement shown in FIG. 7D may provide seating as a complementary accessory while maintaining pass-through modularity for adding another pass-through trailer hitch extension or another complementary accessory to the trailer hitch extension system.

FIG. 7E is a perspective view illustrating an example folding chair set accessory 750 in a partially unfolded state during movement from a transportation configuration toward a usable configuration, in accordance with one or more techniques of this disclosure. In the example of FIG. 7E, the folding chair set accessory 750 is supported relative to a vehicle frame 200 and includes a first chair 752, a second chair 754, a first chair seat 756, a second chair seat 758, a hinge 760, a first chair back 766, and a second chair back 768. The female hitch connection 140 is disposed below the folding chair set accessory 750 and may be configured to operably couple to a male hitch connection of another pass-through trailer hitch extension.

As shown in FIG. 7E, the first chair 752 and the second chair 754 are positioned on opposite lateral sides of the folding chair set accessory 750. The first chair seat 756 is carried by the first chair 752, and the second chair seat 758 is carried by the second chair 754. The first chair back 766 and the second chair back 768 are shown in the process of being raised relative to the first chair seat 756 and the second chair seat 758, respectively, as part of unfolding the folding chair set accessory 750 from the transportation configuration to the usable configuration. In this stage, the first chair back 766 and the second chair back 768 extend upwardly at an inclined orientation relative to the first chair seat 756 and the second chair seat 758, rather than being fully folded against the corresponding chair seats.

In accordance with techniques of the disclosure, the folding chair set accessory 750 may be connected as a complementary accessory to a connection element carried by a support beam of a pass-through trailer hitch extension. The hinge 760 may permit portions of the folding chair set accessory 750 to pivot relative to one another during movement between the transportation configuration and the usable configuration. For example, the first chair back 766 and the second chair back 768 may be raised away from the first chair seat 756 and the second chair seat 758 to position the first chair 752 and the second chair 754 for use at an event site.

The female hitch connection 140 may remain accessible below the folding chair set accessory 750 while the folding chair set accessory 750 is being unfolded. The female hitch connection 140 may thereby permit the pass-through trailer hitch extension carrying the folding chair set accessory 750 to operably couple to a male hitch connection of another pass-through trailer hitch extension, so that multiple pass-through trailer hitch extensions may be coupled in series while supporting one or more complementary accessories.

FIG. 7F is a perspective view of an embodiment of a complementary accessory in a usable configuration while supported relative to a vehicle frame 200. In the example of FIG. 7F, the complementary accessory comprises a folding chair set accessory 750. Folding chair set accessory 750 includes a first chair 752 and a second chair 754. First chair 752 includes a first chair seat 756 and a first chair back 766, and second chair 754 includes a second chair seat 758 and a second chair back 768. Folding chair set accessory 750 is positioned adjacent a female hitch connection 140 and includes a hinge 760 configured to permit folding movement of at least a portion of folding chair set accessory 750 between a transportation configuration and the usable configuration shown in FIG. 7F.

As shown in FIG. 7F, first chair 752 and second chair 754 are arranged laterally relative to one another such that first chair seat 756 and second chair seat 758 extend outwardly from vehicle frame 200 for use by respective users. First chair back 766 extends upwardly from first chair seat 756, and second chair back 768 extends upwardly from second chair seat 758. In accordance with techniques of the disclosure, first chair 752 and second chair 754 may be provided as a complementary accessory connected to a connection element carried by a support beam of a pass-through trailer hitch extension, thereby allowing the pass-through trailer hitch extension to support chair seating while retaining the ability to operably couple with another pass-through trailer hitch extension at female hitch connection 140.

Hinge 760 may permit first chair 752 and second chair 754 to be moved relative to one another and/or relative to a portion of the pass-through trailer hitch extension. For example, folding chair set accessory 750 may be unfolded from a transportation configuration to the usable configuration shown in FIG. 7F. In some embodiments, first chair back 766 and second chair back 768 may fold down toward first chair seat 756 and second chair seat 758, respectively, and first chair 752 and second chair 754 may then fold upwardly toward one another to reduce a footprint of folding chair set accessory 750 during transportation.

Female hitch connection 140 may remain accessible while folding chair set accessory 750 is in the usable configuration. Female hitch connection 140 may be configured to operably couple to a male hitch connection of another pass-through trailer hitch extension. In some embodiments, female hitch connection 140 may include opposing holes configured to receive a pin to secure another pass-through trailer hitch extension. Accordingly, the arrangement shown in FIG. 7F may allow folding chair set accessory 750 to be used as a complementary accessory while preserving pass-through modularity for additional extensions or accessories.

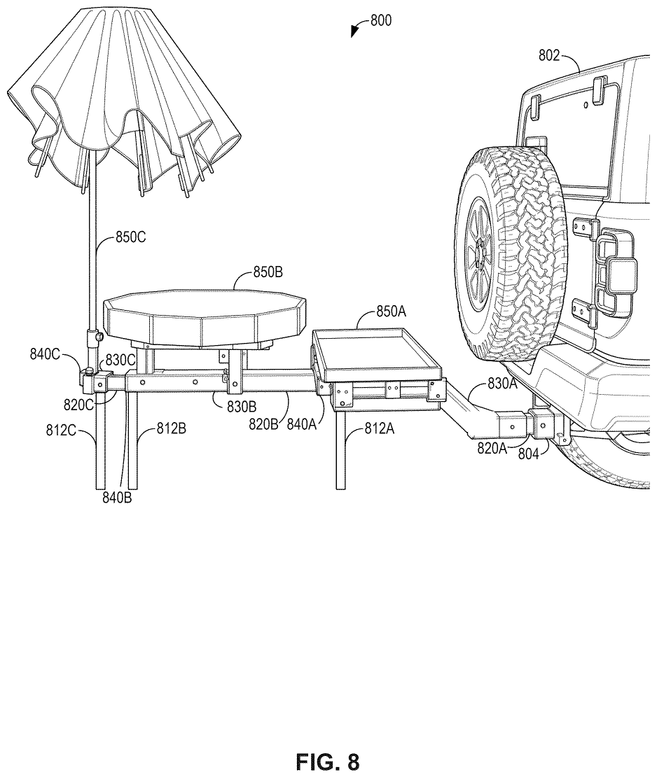

FIG. 8 is a conceptual diagram illustrating an example accessory system 800 including a vehicle 802 having a vehicle hitch connection 804 and a plurality of pass-through trailer hitch extensions operably coupled in series. In the example of FIG. 8, the accessory system 800 includes male hitch connections 820A-820C, support legs 812A-812C, support beams 830A-830C, female hitch connections 840A-840C, a cargo rack accessory 850A, a table accessory 850B, and an umbrella accessory 850C. Each of the cargo rack accessory 850A, the table accessory 850B, and the umbrella accessory 850C may be a complementary accessory connected to a respective connection element carried by a corresponding one of the support beams 830A-830C.

In accordance with techniques described herein, the male hitch connection 820A of a first pass-through trailer hitch extension may attach to the vehicle hitch connection 804 of the vehicle 802. The support beam 830A extends from the male hitch connection 820A, and the female hitch connection 840A is disposed at an opposite end of the support beam 830A from the male hitch connection 820A. The cargo rack accessory 850A may be connected to a connection element carried by the support beam 830A. The support leg 812A may extend downwardly from the support beam 830A and may be configured to engage a ground surface to provide additional support to the first pass-through trailer hitch extension and the cargo rack accessory 850A.

A second pass-through trailer hitch extension may include the male hitch connection 820B operably coupled with the female hitch connection 840A of the first pass-through trailer hitch extension. The support beam 830B extends from the male hitch connection 820B, and the female hitch connection 840B is disposed at an opposite end of the support beam 830B from the male hitch connection 820B. The table accessory 850B may be connected to a connection element carried by the support beam 830B. The support leg 812B may extend downwardly from the support beam 830B and may be configured to engage the ground surface to provide additional support to the second pass-through trailer hitch extension and the table accessory 850B.

A third pass-through trailer hitch extension may include the male hitch connection 820C operably coupled with the female hitch connection 840B of the second pass-through trailer hitch extension. The support beam 830C extends from the male hitch connection 820C, and the female hitch connection 840C is disposed at an opposite end of the support beam 830C from the male hitch connection 820C. The umbrella accessory 850C may be connected to a connection element carried by the support beam 830C. The support leg 812C may extend downwardly from the support beam 830C and may be configured to engage the ground surface to provide additional support to the third pass-through trailer hitch extension and the umbrella accessory 850C.

The arrangement shown in FIG. 8 illustrates that different complementary accessories may be connected to different pass-through trailer hitch extensions of the same trailer hitch extension system. For instance, the cargo rack accessory 850A, the table accessory 850B, and the umbrella accessory 850C may be arranged in series outwardly from the vehicle hitch connection 804 while maintaining a pass-through configuration through the female hitch connections 840A-840C. Although three pass-through trailer hitch extensions and three complementary accessories are shown in FIG. 8, the accessory system 800 may include fewer or additional pass-through trailer hitch extensions, fewer or additional complementary accessories, or different complementary accessories, such as a chair, a grill, a cooler, or a speaker. In some examples, one or more of the support legs 812A-812C may be omitted, and a support leg may instead extend downwardly from a complementary accessory to engage the ground surface.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently rather than sequentially.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1 ½, and 4 ¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A pass-through trailer hitch extension comprising:
a male hitch connection configured to attach to a vehicle hitch connection;
a support beam extending from the male hitch connection;
a connection element carried by the support beam and configured to connect to a complementary accessory; and
a female hitch connection disposed at an opposite end of the support beam from the male hitch connection and configured to operably couple to a male hitch connection of another pass-through trailer hitch extension.

2. The pass-through trailer hitch extension of claim 1, further comprising a support leg extending downwardly from the support beam and configured to engage a ground surface.

3. The pass-through trailer hitch extension of claim 1, wherein the connection element is located on a top side of the support beam.

4. The pass-through trailer hitch extension of claim 1, wherein the connection element comprises a flange having connection holes.

5. The pass-through trailer hitch extension of claim 1, wherein the connection element comprises a clamp.

6. The pass-through trailer hitch extension of claim 1, wherein the support beam comprises a straight square tube.

7. The pass-through trailer hitch extension of claim 1, wherein the support beam comprises a proximal section, a medial section, and a distal section.

8. The pass-through trailer hitch extension of claim 7, wherein the medial section extends away from the proximal section at an angle.

9. The pass-through trailer hitch extension of claim 8, wherein the medial section extends away from the proximal section at a downward angle such that the distal section is positioned at a height lower than the proximal section.

10. The pass-through trailer hitch extension of claim 8, further comprising a strengthening rib, wherein the strengthening rib is disposed adjacent a corner defined by the medial section and one of the proximal section or the distal section.

11. A trailer hitch extension system comprising:
a first pass-through trailer hitch extension comprising a first male hitch connection, a first support beam extending from the first male hitch connection, a first connection element carried by the first support beam, and a first female hitch connection disposed at an opposite end of the first support beam from the first male hitch connection;
a first complementary accessory connected to the first connection element; and
a second pass-through trailer hitch extension comprising a second male hitch connection operably coupled with the first female hitch connection, a second support beam extending from the second male hitch connection, a second connection element carried by the second support beam, and a second female hitch connection disposed at an opposite end of the second support beam from the second male hitch connection.

12. The trailer hitch extension system of claim 11, further comprising a second complementary accessory connected to the second connection element.

13. The trailer hitch extension system of claim 12, wherein the second complementary accessory is different from the first complementary accessory.

14. The trailer hitch extension system of claim 12, wherein at least one of the first complementary accessory and the second complementary accessory comprises a chair, a table, a grill, a cooler, a cargo rack, a speaker, or an umbrella.

15. The trailer hitch extension system of claim 11, wherein the first pass-through trailer hitch extension comprises a support leg extending downwardly from the first support beam and configured to engage a ground surface.

16. The trailer hitch extension system of claim 11, wherein the first complementary accessory comprises an accessory leg extending downwardly from the first complementary accessory and configured to engage a ground surface.

17. A method of assembling a trailer hitch extension system, the method comprising:
attaching a male hitch connection of a first pass-through trailer hitch extension to a vehicle hitch connection;
connecting a complementary accessory to a connection element carried by a support beam of the first pass-through trailer hitch extension; and
coupling a male hitch connection of a second pass-through trailer hitch extension to a female hitch connection of the first pass-through trailer hitch extension.

18. The method of claim 17, further comprising unfolding the complementary accessory from a transportation configuration to a usable configuration.

19. The method of claim 17, further comprising securing the male hitch connection of the first pass-through trailer hitch extension to the vehicle hitch connection with a removable pin.

20. The method of claim 17, further comprising inserting a pin through opposing holes formed in the female hitch connection of the first pass-through trailer hitch extension to secure the second pass-through trailer hitch extension to the first pass-through trailer hitch extension.
